(19) United States
(12) Patent Application Publication
(10) Pub. No.: US 2008/0309132 A1
(43) Pub. Date: Dec. 18, 2008

(54) Method for Improving Blood Circulation

(75) Inventor: Jiro Katsuta, Krefeld (DE)

Correspondence Address: BERENATO, WHITE & STAVISH, LLC, 6550 ROCK SPRING DRIVE, SUITE 240, BETHESDA, MD, 20817, US

(73) Assignee: IBFK GMBH, Krefeld (DE)

(21) Appl. No.: 11/883,512

(22) PCT Filed: Jan. 24, 2006
(86) PCT No.: PCT/EP06/00598

§ 371 Date: Aug. 1, 2007

(30) Foreign Application Priority Data
Feb. 2, 2005 (EP) 05002115.3
Sep. 19, 2005 (EP) 05020407.2

(51) Int. Cl. A47C 31/00; G01N 29/00

(52) U.S. Cl. 297/217.3; 73/596

(57) ABSTRACT

A method for improving blood circulation of seated or lying persons, wherein vibrations are released locally into the areas of the body of the seated or lying person, which are susceptable to blood stasis, by at least one vibration device (5) disposed beneath the sitting or lying surface with a predetermined or determinable frequency, characterized in that the vibrations are released by means of at least one vibration plate (6), which is movably guided in a direction transverse to the plane of the vibration plate (6) towards and away from the sitting or lying surface linearly and is operated with a frequency in the range of 5 to 30 Hz, so that the body is alternately raised and lowered from the sitting or lying surface, a brief pressure release occurring during the lowering movement so that a blood circulation can take place.

This invention relates to a method for improving blood circulation with seated or lying people. Furthermore, the invention relates to a seat or lying furniture for implementing this method.

On long journeys by car, bus or aeroplane, the problem often occurs that the legs are only insufficiently supplied with blood, and this leads to so-called blood stasis. The cause of this is that with a seated person, nearly the whole body weight is borne upon the thighs with the result that the dermal tissue and the vessels in the thigh regions which come into contact with the vehicle seat are subjected to a high level of pressure which prevents further blood circulation. As a result, a feeling of numbness is experienced in the legs, and with long flights, there is even the risk of embolisms.

A similar problem also occurs with bedridden people. As a result of continuous lying bed sores (decubitus) may occur in the typical supporting areas, i.e. in the region of the shoulder blades and the pelvis as well as the heels. For this reason bedridden patients in hospitals are moved regularly. By this measure the problem described before may however not be solved on a long-term basis.

It is therefore the objective of this invention to provide a method with which the circulation of blood of seated or lying people can be supported. Furthermore, furniture for sitting and lying should be provided with which the method can be implemented.

This objective is fulfilled according to the invention in that vibrations are released locally into the areas of the seated or lying person where blood stasis are to be awaited by means of at least one vibration device disposed beneath the sitting or lying surface with a predetermined or determinable frequency of 5 to 30 Hz. The idea which forms the basis of the invention is therefore to release vibrations with a desired frequency and amplitude specifically into the thigh regions of a seated person where the greatest pressure forces occur, and so where there is a risk of a bad blood circulation and in the worst case of blood stasis. The result of these vibrations is that the body is alternately raised and lowered in these support regions, a brief pressure release occurring during the lowering movement so that blood circulation can take place. Furthermore, the vibrations bring about a type of pump effect which stimulates the circulation of blood.

Tests have shown that a good effect is achieved if the vibrations lie within a frequency range of 20 to 30 Hz, and have an amplitude of between 0.5 and 2 mm, and in particular between 1 and 2 mm.

Preferably, the vibrations are produced cyclically because continuous vibration is unpleasant. It has been shown that the introduction of vibrations in several cycles each of which can last for less than a minute, for example approx. 30 seconds, are absolutely sufficient. If several vibration cycles are produced one after the other, it is advantageous to start first of all with a lower vibration intensity and then to increase the intensity from cycle to cycle. In this way it is avoided, for example, that a car driver is startled when vibrations start.

As already mentioned initially in case of a sitting person the thighs resting on the seating surface are exposed to particularly high pressures, so that here in the first line the danger of blood stasis exists. Accordingly the above mentioned object is solved with a seat according to the present invention in that in the seat body beneath the supporting areas for the thighs of the seating surface to vibration devices are provided for releasing vibrations into the thigh regions of a person seated on the seat.

In a lying furniture according to the present invention this object is solved in that in the body beneath the bearing area for the head and/or the bearing areas for the shoulder and/or the bearing area for the pelvis and/or the bearing areas for the heels of the lying surface at least one vibration device is provided, respectively, in order to release vibrations into the head and/or the shoulders and/or the pelvis and/or the heals of a person lying on the lying furniture.

According to an embodiment of the present invention it is provided, that the vibration devices each have a vibration plate, which can be set into vibration by means of a vibration producer. In the case of a seat the vibration plates are disposed in an approximate V-shape extending apart from one another towards the front edge of the seat, so that the thighs of a seating person rest on the vibration plates extensively.

Basically, it is possible to stimulate both vibration plates by means of a common vibration producer. Preferably, each of the two vibration plates is allocated its own vibration producer, the vibration producers being coordinated with one another in such a way that they stimulate the vibration plates alternately and in the opposite direction.

Trials have shown that an optimal effect is achieved if the vibration plates can be moved alternately and in the opposite direction to one another. Basically, however, it is also possible to cause the vibration plates to vibrate parallel to one another and in phase.

According to one preferred embodiment, the vibration device has a housing or a frame on which the vibration plates are held and supported on their side facing away from the sitting or lying surface. The support can be for example in the form of a hydraulic system wherein preferably the support pressures on the support points can be set independently of one another so that the vibration plates can be raised, lowered and tilted by acting correspondingly upon the individual support points, with the result that a required desired position of the vibration plates can be set independently of the pressure applied by a person sitting or lying on the item of furniture. Advantageously, there is automatic regulation of the hydraulic system here which means that the vibration plates take a predetermined initial position before they are caused to vibrate.

In order to produce vibrations with the seat or lying furniture described above, it is proposed according to one example of an embodiment that a vibration mass is introduced in the same which is coupled with the vibration plates and can be caused to vibrate by stimulation means.

In order to take into account variable parameters such as for example the mass of the person using the seat or lying furniture, the vibration mass and the vibration plates are coupled to one another in such a way that the ratio of their vibration amplitudes to one another is adjustable. In this way, the amplitude of the intermediary mass can be adapted to the weight of the person. If the weight of the person to be supported is for example 40 kg, and the weight of the intermediary mass is 8 kg, according to the law of conservation of momentum, a coupling is desirable which makes possible a vibration ratio of the intermediary mass to the vibration plates of 5:1. For example, stimulation of the vibration mass and/or the coupling of the vibration mass with the vibration plates can take place by means of plunger coil systems.

With regard to further advantageous embodiments of the invention, reference is made to the sub-claims and to the following description of an example of an embodiment, with reference to the attached drawings. In the drawings:

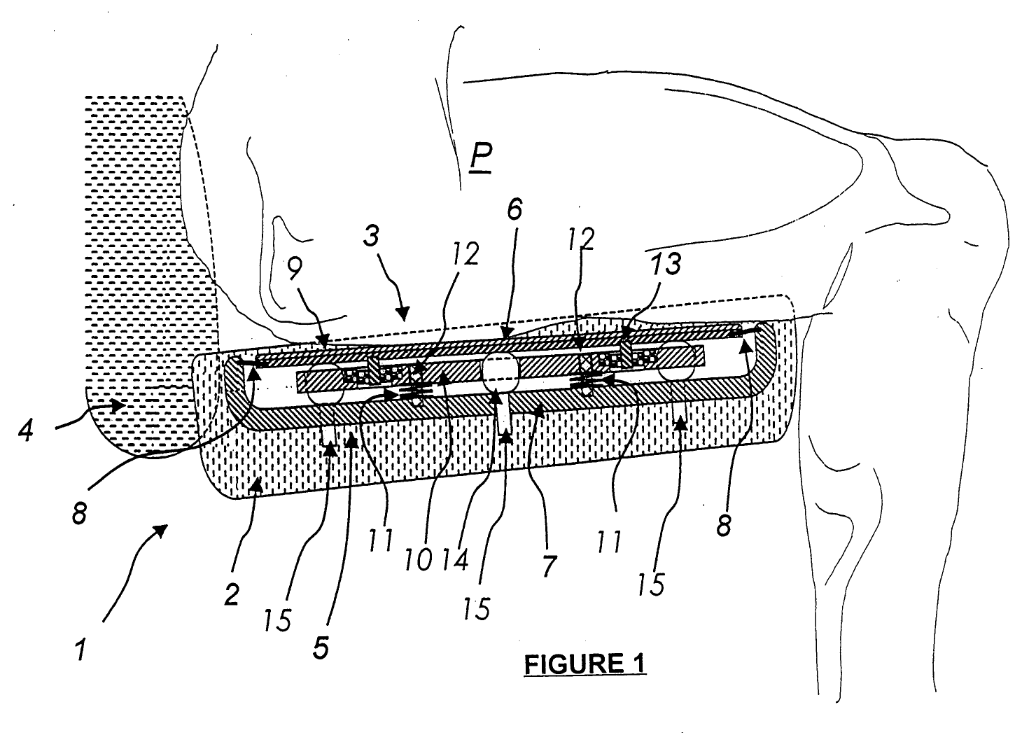

FIG. 1 shows a sectional view of a seat according to the invention with a person sitting on the same,

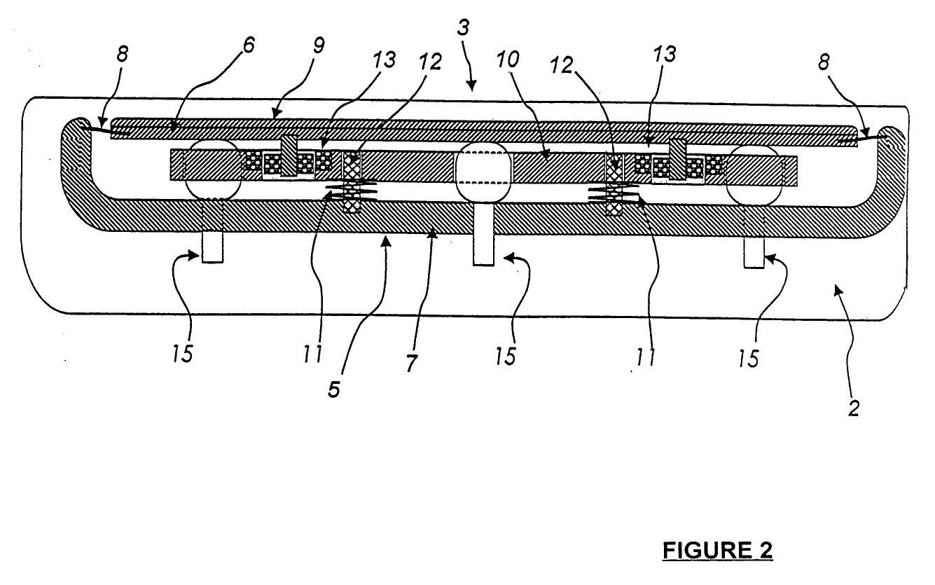

FIG. 2 shows an enlarged representation of the seat body of the seat from FIG. 1,

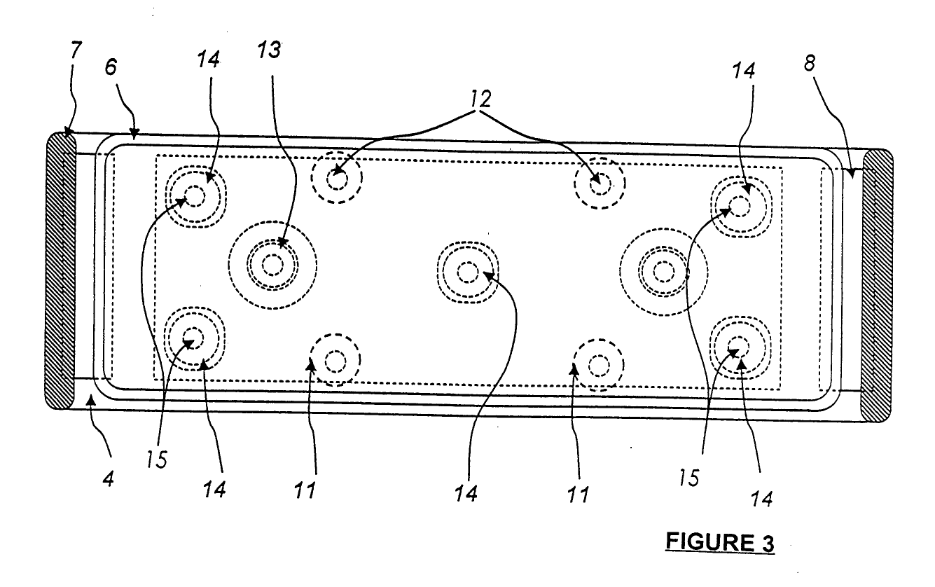

FIG. 3 shows the seat body from FIG. 2 in an overhead view,

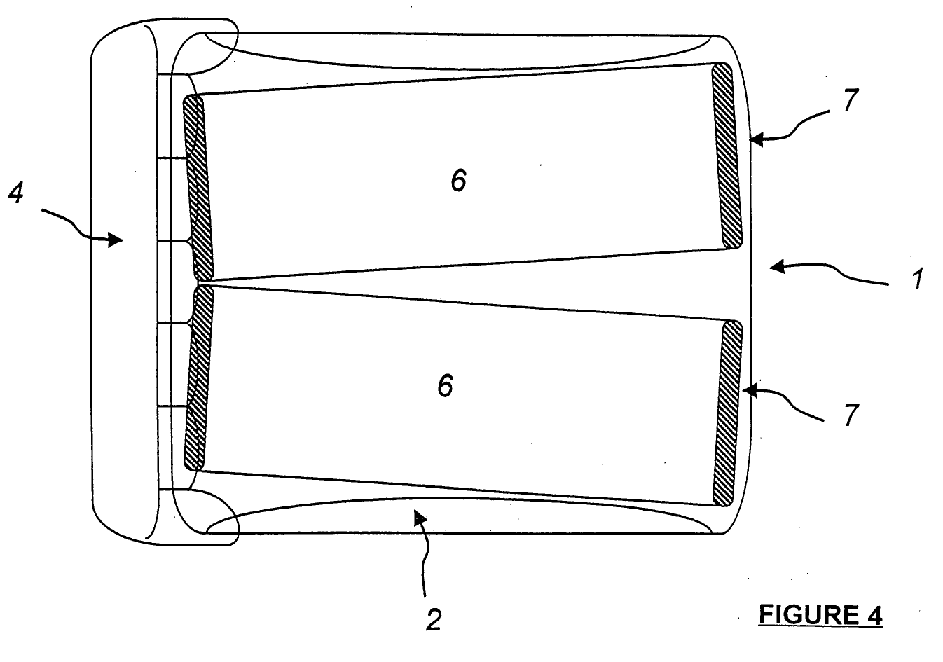

FIG. 4 shows the vibration device of the seat from FIG. 3 in an overhead view,

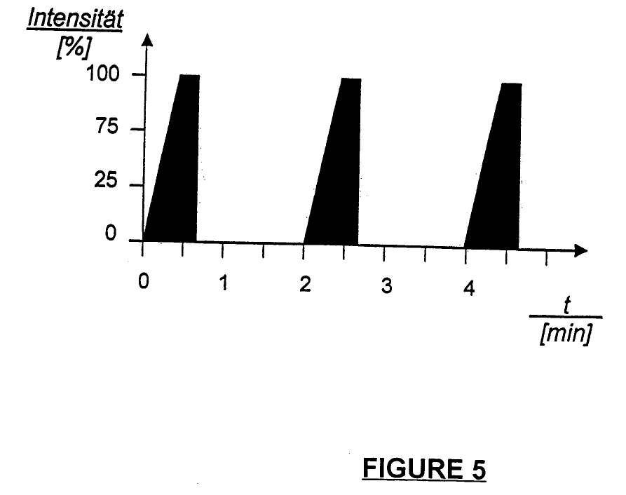

FIG. 5 shows a diagram in which the cyclical vibration release according to a method of this invention is illustrated, and

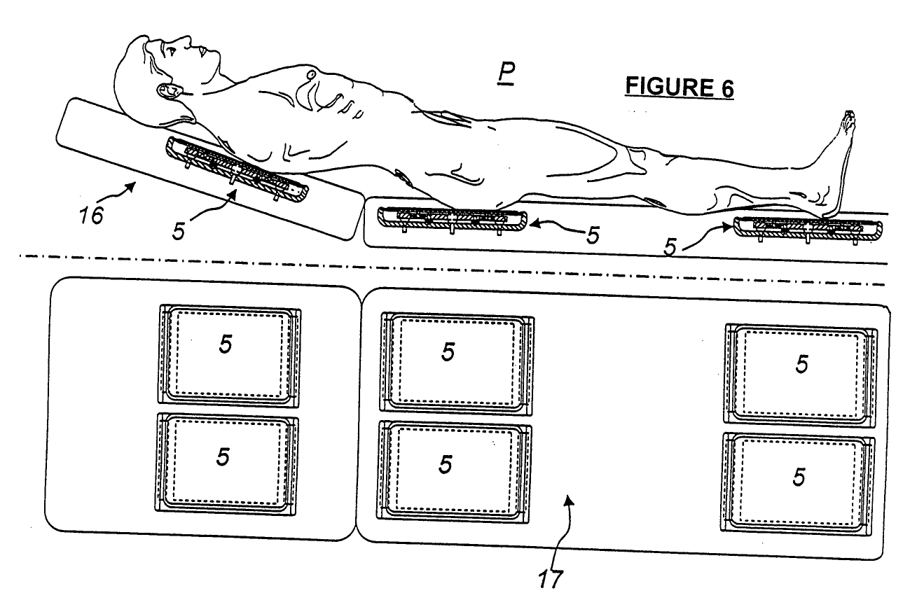

FIG. 6 shows a lying furniture according to the present invention in a diagrammatic elevation view and overhead view.

FIGS. 1 to 4 show a seat according to this invention which can be used here as a vehicle seat 1 for a car, an aeroplane or similar. The vehicle seat 1 has a seat body 2 which, on its upper side, has a sitting surface 3 and a back-rest 4. Two vibration devices 5 are provided in the seat body 2, and these serve to release vibrations into the thighs of a person P sitting on the seat. The vibration devices 5 each have an oblong vibration plate 6 which is suspended on a frame or housing 7 of the vibration device 5 by means of flat springs 8 and is provided with a gel support 9 on its upper side facing the sitting surface 3.

A vibration producer is accommodated within the housing 7 in order to cause the vibration plate 6 to vibrate. This vibration producer comprises a vibration mass 10 which is supported on the housing 7 by springs 11, and movably guided on guide pins 12 which pass through the springs 11 transverse to the plane of the vibration plate 6, i.e. towards and away from the sitting surface 3. The vibration mass 10 is coupled with the vibration plate 6 by a plunger coil system 13 which, when stimulated, causes the vibration plate 6 and the vibration mass 10 to vibrate, the frequency and amplitude of said vibrations being adjustable by means of a control unit.

In addition, the vibration plate 6 is supported in the housing 7 on its lower side facing away from the sitting surface 3. More precisely, the support is in the form of five balloons 14 filled with hydraulic media which are positioned in the four corner regions and in the centre of the rectangular vibration plate 6 so as to support the vibration plate 6 evenly. The balloons 14 are connected by supports 15 to a hydraulic medium system by means of which hydraulic fluid can be introduced or removed, as required. Because the pressure exerted on the vibration plate 6 by the person P using the seat is unevenly distributed from the front side of the seat to the rear side of the seat, the hydraulic system is designed so that the balloons 14 can be controlled individually or in pairs so as to feed hydraulic fluid to them or to remove it from them. It can not be seen in the drawings that an automatic regulation system is provided which records the position and location of the vibration plate 6 and feeds hydraulic means to the balloons 14 or removes it in such a way that the vibration plate 6 takes a required desired position. In this way it is guaranteed that the vibration plate 6 takes a required initial position independent of the weight and shape of the person P. The regulation system also ensures that the position of the vibration plate 6 is readjusted when the person P changes their sitting position.

The two vibration devices 5 are, as can be seen particularly well in FIG. 4, disposed in a slight V-shape such that the vibration plates 6 extend apart from one another slightly from the rear side to the front side of the seat 1 so that the thighs of the person P, sitting in a normal way, are positioned on the vibration plates 6.

The vibration devices 5 form constructionally separate units, but their vibration producers are co-ordinated with one another so that, when activated, the vibration plates 6 are stimulated alternately and in opposite directions so as to release vibrations by means of the vibration plates 6 into the thighs of the person P sitting on the seat 1 with a desired frequency and amplitude. The result of these vibrations of the vibration plate 6 is that the thigh is raised with an upwards movement of the vibration plate 6 and briefly released from pressure with the subsequent lowering movement of the vibration plate 6 so that blood circulation can take place. Furthermore, the vibrations bring about a type of pump effect which stimulates blood circulation.

As shown in FIG. 5, with automatic operation, the vibrations are released in three application cycles which each last approximately 40 seconds, the vibration intensity at the start of each cycle continuously being increased to a predetermined desired value. In the examples of embodiments shown, the maximum intensity in all three application cycles is the same. There is however also the possibility of increasing the intensity from cycle to cycle. Of course it is also possible to adjust and switch the vibration devices individually by hand. Trials have shown that good results are achieved if vibrations with a frequency of 5 to 30 Hz, and in particular from 20 to 30 Hz and with an amplitude of 0.5 to 2 mm, in particular of 1 to 2 mm are released into the body.

Finally in FIG. 6 a lying furniture 16 according to the present invention is depicted diagramatically. As already explained initially the shoulder blades, the pelvis and the heels of a lying person P are particularly susceptable to blood stasis and a result decubitus. Accordingly the vibration devices 5 of the lying furniture 16 according to the present invention are provided at the respective supporting areas in the mattress 17. These vibration devices 5 have the same structure as the vibration device 5 provided in the vehicle seat 1 as described before, so that it is referred to the respective explanations.

It is to be noted, that the resting areas each have a pair of two vibration devices 5 associated thereto, which likewise the two vibration devices 5 of the vehicle seat preferably operated alternately and in the opposite direction to one another.

Finally, it is also possible to allocate vibration devices to the feet, and these can for example be incorporated into the aeroplane floor.

1. A method for improving blood circulation of seated or lying persons, characterized in that vibrations are released locally into the areas of the body of the seated or lying person, which are susceptable to blood stasis, by at least one vibration device (5) disposed beneath the sitting or lying surface with a predetermined or determinable frequency of 5 to 30 Hz.

2. Method according to claim 1 for improving blood circulation of a seated person, characterized in that the vibrations are released into the thighs of the person.

3. Method according to claim 2, characterized in that the vibrations are released into the thighs by two vibration plates (6) which are caused to vibrate in the opposite direction to one another.

4. Method according to claim 1, characterized in that in case of a lying person the vibrations are released into the head and/or the shoulders and/or the pelvis and/or the heels of the person.

5. Method according to claim 1, characterized in that the vibrations are produced cyclically, one vibration cycle lasting up to a minute, and in particular approximately thirty seconds.

6. Method according to claim 5, characterized in that several vibration cycles are produced, one after the other, the vibration intensity being increased from cycle to cycle.

7. Method according to claim 1, characterized in that the vibrations are produced with a frequency of 20 to 30 Hz.

8. The method according to claim 1, characterised in that the vibrations have an amplitude of 0.5 to 2 mm, and in particular 1 to 2 mm.

9. A seat, in particular for vehicles and aeroplanes, with a seat body (2) which forms a sitting surface (3), and if required a back-rest (4), characterized in that a vibration device (5) is provided in the seat body (2) beneath the thigh support regions of the sitting surface (3) in order to release vibrations into the thighs of a person (P) sitting on the seat (1).

10. The seat according to claim 9, characterized in that the vibration device comprises two vibration plates (6) that can be caused to vibrate alternately and in particular in opposite directions by means of a vibration producer.

11. The seat according to claim 10, characterized in that the vibration plates (6) are disposed in an approximate V-shape extending a part from one another towards the front side of the seat.

12. The seat according to claim 10, characterized in that a vibration producer is allocated to each of the two vibration plates (6), the vibration producers being coordinated with one another so that they stimulate the vibration plates (6) alternately and in opposite direction.

13. Lying furniture, in particular a bed, with a base body forming a lying surface, characterized in that in the base body (17) beneath the supporting area for the head and/or the supporting areas for the shoulders and/or the supporting area for the pelvis and/or the supporting areas for the heels of the lying surface at least one vibration device (5) is disposed in order to release vibrations into the head and/or the shoulders and/or the pelvis and/or the heels of a person lying on the lying furniture with a predetermined or determinable frequency of 5 to 30 Hz.

14. Lying furniture according to claim 14, characterized in that the vibration device (5) comprises a vibration plate (16) that can be set into vibration by means of a vibration producer.

15. The seat or lying furniture according to claim 10, characterised in that the vibration plates (6) are suspended resiliently in a housing (7) of the vibration device.

16. The seat or lying furniture according to claim 15, characterized in that the vibration plates (6) are supported in the housing (7) on their lower side facing away from the sitting surface.

17. The seat or lying furniture according to claim 16, characterized in that the vibration plates (6) are hydraulically supported on the housing (7).

18. The seat or lying furniture according to claim 17, characterized in that the vibration plates (6) are hydraulically supported at several points, the support pressure of the hydraulics being separately adjustable at the support points (14).

19. The seat or lying furniture according to claim 14, characterized in that a gel support (9) is provided on the sides of the vibration plates (6) facing the support surface.

20. The seat or lying furniture according to claim 15, characterised in that a vibration mass (10) is introduced in the housing (7) of the vibration device (5) which is coupled to the vibration plate (6) and can be caused to vibrate by stimulation means.

21. The seat or lying furniture according to claim 20, characterized in that the vibration mass (10) and the vibration plates (6) are coupled to one another in such a way that the ratio of their vibration amplitudes to one another is adjustable.

22. The seat or lying furniture according to claim 20, characterized in that the stimulation of the vibration mass (10) and/or the coupling of the vibration mass (10) to the vibration plates (6) is achieved by means of plunger coil systems.
